(19) United States
(12) Patent Application Publication
(10) Pub. No.: US 2008/0172486 A1
(43) Pub. Date: Jul. 17, 2008

(54) Method and Arrangement for Handling Client-Related Information in an Application Server

(76) Inventors: Anders Danne, Kista (SE); Anders Lindgren, Alvsjo (SE); Christer Boberg, Tungelsta (SE)

Correspondence Address: ERICSSON INC., 6300 LEGACY DRIVE, M/S EVR 1-C-11, PLANO, TX, 75024, US

(21) Appl. No.: 11/913,139

(22) PCT Filed: May 2, 2006
(86) PCT No.: PCT/SE2006/000525

§ 371 Date: Nov. 13, 2007

(30) Foreign Application Priority Data
May 4, 2005 (SE) 0501043-4
Jun. 9, 2005 (EP) 05445042.4

(51) Int. Cl. G06F 11/30

(52) U.S. Cl. 709/224

(57) ABSTRACT

A method and arrangement for handling client-related information in an application server connected to a telecommunication network for a client that has registered with the network. The application server receives a message from the client that results in the activation of a client state in the server. The server then creates a subscription with a registration unit such as an S-CSCF for monitoring registration events when the client's registration is changed. When the application server receives a registration event notification from the registration unit, the server updates the client state in response thereto.

### TECHNICAL FIELD

The present invention relates generally to a method and arrangement for handling client-related information in an application server connected to a telecommunication network. In particular, the invention is concerned with reducing the amount of signalling when a client state is maintained in the application server.

### BACKGROUND

With the emergence of 3G mobile telephony, new packet-based communication technologies have been developed for communicating multimedia content. For example, GPRS (General Packet Radio Service) and WCDMA (Wideband Code Division Multiple Access) technologies support wireless multimedia telephony services involving packet-switched communication of data representing images, text, documents, animations, audio files, video files, etc., in addition to traditional circuit-switched voice calls. The term “multimedia content” will be used in this description to represent any data communicated by means of packet-switched transport.

Recently, a network architecture called “IP Multimedia Subsystem” (IMS) has been developed by the 3^{rd} Generation Partnership Project (3GPP) as an open standard, to provide multimedia services for mobile clients in the packet domain. Generally, IMS is a platform for enabling services based on IP transport, more or less independent of the access technology used and basically not restricted to any limited set of specific services.

A specification for session setup has been defined called “SIP” (Session Initiation Protocol, according to the standard IETF RFC 3261 et al), which is an application-layer control (signalling) protocol for creating, modifying and terminating sessions over a packet-switched logic. SIP is generally used by IMS networks for establishing multimedia sessions.

FIG. 1 illustrates schematically a basic network structure for providing multimedia services by means of an IMS service network. It should be noted that the figure is greatly simplified and only shows a selection of network nodes helpful to understand the context of the present invention. A calling mobile terminal A is connected to a first radio access network 100 and communicates with a called mobile terminal B connected to a second radio access network 102, in a communication session S involving one or more multimedia services. Alternatively, terminal A may communicate with a fixed terminal or computer or a content server delivering some multimedia content to the terminal, such as a piece of music, a film or a game.

An IMS network 104 is connected to the first radio access network 100 and handles the session with respect to terminal A, as initiated by its user. In fact, the IMS network 104 receives and processes any service requests or data from the user of terminal A. In this figure, a corresponding IMS network 106 handles the session on behalf of terminal B, and the two IMS networks 104 and 106 may be controlled by different operators. Similarly, the IMS network 106 receives and processes any service requests or data from the user of terminal B. Alternatively, terminals A and B may of course be connected to the same access network and/or belong to the same IMS network.

The illustrated session S is managed, using SIP signalling, by a node called S-CSCF (Serving Call Session Control Function) 108 assigned to terminal A in the IMS network 104, and the used multimedia service is enabled and executed by an application server 110. Basically, the S-CSCF node 108 serves as a proxy for the application server 110 towards terminal A and sends SIP messages from terminal A to the IMS network 106 of terminal B, as indicated by a dashed arrow. Further, a main database element HSS (Home Subscriber Server) 112 stores subscriber and authentication data as well as service information, among other things, that the application server 110 may need to fetch for executing services for clients. Typically, the S-CSCF node 108 fetches information from the HSS 112 to determine which application server 110 to handle a service requested by terminal A, as determined by “triggers” in the HSS 112.

A node called I-CSCF (Interrogating Call Session Control Function) 114 is connected to other IMS networks, in this case network 106, and acts as a gateway for SIP messages from other IMS networks. I-CSCF 114 receives SIP messages from the IMS network 106 of terminal B, as indicated by another dashed arrow. Another node called P-CSCF (Proxy Call Session Control Function) 116 acts as an entry point towards the IMS network 104 from any access network, such as network 100, and all signalling flows between clients and the IMS network 104 are routed through the P-CSCF 116.

The various functions of the I-CSCF and P-CSCF nodes 114, 116 are not necessary to describe here further to understand the context of the present invention. Of course, the IMS network 104 contains numerous other nodes and functions, such as further S-CSCF nodes and application servers, which are not shown here for the sake of simplicity. Basically, the IMS network 106 comprises the same type of nodes as network 104. The shown application server 110 may be configured to provide one or more specific multimedia services to clients.

Two important examples of services that can be employed by means of an IMS network are “Instant Messaging” (IM) and “Presence” services, using SIP signalling for controlling sessions. Instant Messaging involves the transmission of relatively short messages between terminals, e.g. including text, pictures, logos, audio/video clips, etc., in “near real-time”, i.e. with small delays. In this context, “Presence” is basically a dynamic and variable state profile of a client, and the presence services basically involve the publishing of “presence data” of a client to make it available for other users, which furthermore can be used to control other services in turn. Presence data basically defines the state of a client and his/her equipment in any predefined respect. Thus, the term “presence” is here given a very broad meaning, and the following “client states” may for example make up the presence data:
A personal status, e.g. available, busy, in a meeting, on holiday, etc.
A terminal status, e.g. switched on/off, engaged, out of coverage, etc.
The geographic location of the client/terminal.
Terminal capabilities, e.g. functionality for SMS, MMS, chat, IM, video, etc.
Terminal selections, e.g. call forwarding, language, etc.
Other client information, e.g. interests, occupations, personal characteristics, moods, personal logos, logo depending on the current mood, etc.

This information, or any selected parts thereof, is stored in an application server in the IMS network, based on so-called “publications of events” received from the network or a client, whenever the client changes any of his/her presence data. According to some services, a client may also subscribe for selected presence data of one or more other users, e.g. according to a list of users. Such presence subscriptions are typically also handled by an application server in the IMS network.

A SIP message called “SIP PUBLISH” is generally used by clients, or rather “User Agent Clients (UAC)”, to upload dynamic data to an application server in the IMS network. Publication of data can be used by any service for this purpose, such as PoC, IM, and Presence services. Another SIP message called “SIP SUBSCRIBE” is used by clients to subscribe for dynamic data of other clients, as handled by the application server. In this description, the term “client state” will be used to represent the maintenance of client-related information in an application server during a limited time period as determined by a pre-set expiry time, sometimes referred to as TTL (Time To Live). Such client-related information may relate to published client data or a client's subscription for data of other users. However, these services may result in a large amount of messages that are sent from clients towards the IMS network, in particular for Presence services.

Thus, a client state for published client data or requested data subscriptions must have an expiry time, such that the published data or data subscription becomes invalid as the time expires. If no expiry time is provided by the client, the application server will use a default expiry time, typically one hour in the Presence case. In the current service implementation and according to the different standards of IETF, 3GPP and OMA, the data publication or subscription must be frequently refreshed in order to maintain the data/subscription valid in the application server, even if the data/subscription is not changed during this period.

A conventional procedure for maintaining published client-related data in an application server will now be described with reference to a block diagram shown in FIG. 2. A client terminal 200 has been powered-on by its user and is currently connected to an access network, not shown, in order to communicate with other terminals and also with a multimedia service network 202, such as an IMS network as described above. The service network 202 includes, among other nodes and components, a “registration unit” 204, an application server 206 and an HSS 208, e.g. in accordance with the IMS network shown in FIG. 1. The registration unit 204 may thus be an S-CSCF node as described above, and generally handles the client's registration with the service network 202. Here, it is assumed that, when initially accessing the access network, a temporary IP address has been assigned to the terminal such that the terminal can generally communicate over IP.

In a first step 2:1, terminal 200 sends a registration request message to registration unit 204, in order to become registered as an active terminal in the service network 202. Next, the terminal becomes registered in the HSS 208, as indicated in a step 2:2, according to conventional routines, not further described here. Thereafter, the terminal is obliged to refresh the registration by frequently sending “re-register” messages or the like to the registration unit 204, as generally indicated by dashed arrows 2:3. Typically, a re-register message must be sent every 30-60 minutes in order to maintain the registration.

At some point during this ongoing routine, terminal 200 sends a client data publication message, e.g. a SIP PUBLISH message, to application server 206, in a step 2:4. Application server 206 will then store the new client data, which will remain valid during a time-out period, e.g. set to 30 minutes or one hour. Generally, the client data publication message results in the activation of a “client state” in the application server 206 during which the published data is valid. In order to maintain this client state, i.e. the published data, in the application server 206, the terminal must refresh the published data by frequently sending a “re-publish” message before the time-out period expires, as generally indicated by dashed arrows 2:5, even if the data has not changed. If a client has a multitude of various active client states in the network 104, the burden of sending such refreshing messages can be significant.

If the terminal 200 is eventually turned off, a “de-register” message is finally sent to the registration unit 204, in a step 2:6. Typically, the terminal is also obliged to send a “de-publish” message, not shown, to the application server 206 to inactivate the published data. Otherwise, the published data will remain valid in the application server 206 until the time-out period finally expires, as from the last re-publish message was sent, even though the terminal has been turned off. This may result in irrelevant active client states after the client has logged off and until the TTL has expired. In particular, this would be the case if terminal 200 accidentally looses its radio connection, e.g. due to battery failure, thereby preventing the sending of a de-publish message.

Basically, the same procedure would be used when the client sends a subscription request for data of other clients, as described above. In that case, the message of step 2:4 would be a subscription request message, e.g. a SIP SUBSCRIBE message, resulting in the activation of another client state in the application server 206. Furthermore, the refreshing messages of step 2:5 would be a frequently-sent “re-subscribe” message in order to maintain this client state. However, there are some problems associated with having the client's terminal 200 frequently sending re-publish and/or re-subscribe messages, as explained below.

In the current solution, the client must either refresh the published data or data subscription with quite high frequency, or increase the expiry time for the published data, for the following reasons. Firstly, in order to keep client states up-to-date in application servers, it is generally desired to have a short expiry time for a client state, e.g. published data or a data subscription, and as a result it is necessary to refresh the publication quite frequently. A major reason for having a short expiry time is also the fact that the application server 206 will not know whether a client has been shut down without sending a de-publish or de-subscribe message to change the state of the data or subscription to “off”. The client state is then maintained in vain and unnecessary notifications may be frequently sent towards a terminal that cannot receive them but still has an active subscription for data of other clients, until the TTL expires.

Secondly, this behaviour results in a huge amount of extra load on both the service network 202 as well as the used access network, which in the IMS case is normally based on radio access. In addition, in the case of a mobile client, the frequent sending of re-publish or re-subscribe messages, as in step 2:5 above, will drain the terminal battery and consume precious radio bandwidth. Therefore, it would be advantageous to have a relatively long expiry time for a client state with respect to the signalling load. Hence, in the conventional solution described above, the expiry time for client states in application servers must inevitably be set in a compromise between these conflicting factors.

### SUMMARY

The object of the present invention is to address at least some of the problems outlined above. In particular, it is an object to enable reduced signalling load from clients having active client states in application servers. Another object is to enable that client-related information in an application server can be kept up-to-date using a minimum of signalling messages.

These objects and others can be obtained in a method and arrangement for handling client-related information in an application server connected to a telecommunication network, for a client who has registered with said telecommunication network, in accordance with the appended independent claims. In the method, a message is first received from the client that results in the activation of a client state in the application server. Registration events, i.e. events when the client's registration is changed, are then monitored. At some point, a registration event notification concerning the client is received and the client state is updated in response to the received registration event notification.

The message received from the client may include the publication of client data or a subscription request for client data, or may be a session initiation message, e.g. SIP INVITE. Monitoring registration events may include creating a subscription for registration events, or registration events of a third party may be monitored.

The received registration event notification typically indicates that the client's registration with the telecommunication network has been inactivated. The client's registration may have been inactivated when receiving a de-register message from the client. Typically, the client's registration with the telecommunication network has a limited time of validity and the client's registration with the telecommunication network may have been inactivated when the time of registration validity has expired. The client state is preferably inactivated in the application server in response to inactivation of the client's registration with the telecommunication network.

Typically, also the client state in the application server has a limited time of validity, and the expiry time of client state validity is then preferably set significantly longer than the expiry time of registration validity. For example, the expiry time of state validity may be set to at least 10 times the expiry time of registration validity.

The telecommunication network may be an IMS network, and said registration event notification is then received from an S-CSCF node that handles the client's registration with said IMS network. In this case, SIP is used for communicating messages with the client.

An arrangement in an application server connected to a telecommunication network, for handling client-related information for a client who has registered with said telecommunication network, is also provided. The arrangement includes means for receiving a message from the client that results in the activation of a client state in the application server, means for monitoring registration events, i.e. events when said client registration is changed, means for receiving a registration event notification concerning the client, and means for updating said client state in response to the received registration event notification.

The arrangement may further comprise means for receiving said message from the client including the publication of client data, means for receiving said message from the client including a subscription request for client data, and means for receiving said message from the client as a session initiation message, e.g. SIP INVITE. The means for monitoring registration events may be adapted to create a subscription for registration events, or to monitor registration events of a third party.

The arrangement may further comprise means for receiving said registration event notification indicating that the client's registration with said service network has been inactivated. The client's registration with said service network may have been inactivated when receiving a de-register message from the client. Typically, the client's registration with said service network has a limited time of validity, and the client's registration with said service network may have been inactivated when the time of registration validity has expired.

The arrangement may further comprise means for inactivating said client state in response to inactivation of the client's registration with the telecommunication network. Typically, also the client state in the application server has a limited time of validity. The arrangement may then further comprise means for setting the expiry time of client state validity significantly longer than the expiry time of registration validity, and preferably means for setting the expiry time of client state validity to at least 10 times the expiry time of registration validity.

The telecommunication network is typically an IMS network, and said registration event notification is then received from an S-CSCF node that handles the client's registration with said IMS network. In this case, SIP is used for communicating messages with the client.

Further features and benefits will be explained in the detailed description below.

### BRIEF DESCRIPTION OF THE DRAWINGS

The present invention will now be described in more detail by means of preferred embodiments and with reference to the accompanying drawings, in which:

FIG. 1 is a schematic overview of a basic communication scenario in which the present invention can be used.

FIG. 2 is a block diagram illustrating a conventional procedure for maintaining client data in an application server.

FIG. 3 is a block diagram illustrating a procedure for handling client-related information in an application server, in accordance with one embodiment.

FIG. 4 is a signalling diagram illustrating a procedure for maintaining client data, in accordance with another embodiment.

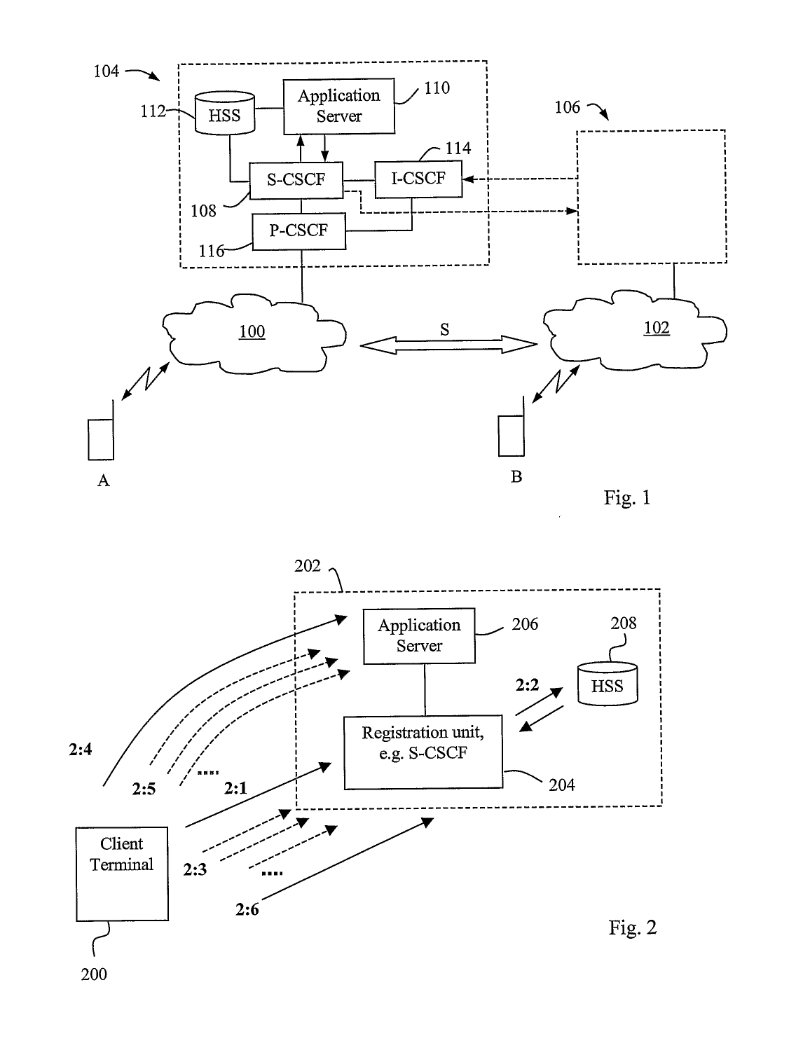

### DETAILED DESCRIPTION

Basically, the present solution can utilise the existing routine of the client sending re-registration messages to a registration unit, e.g. as described in step 2:3 of FIG. 2 above, to also “refresh” any client states activated in an application server, e.g. for published data or data subscriptions. In this way, in addition to refreshing the client registration, published data or data subscriptions can be automatically refreshed without having the client frequently sending specific re-publish and re-subscribe messages to the application server.

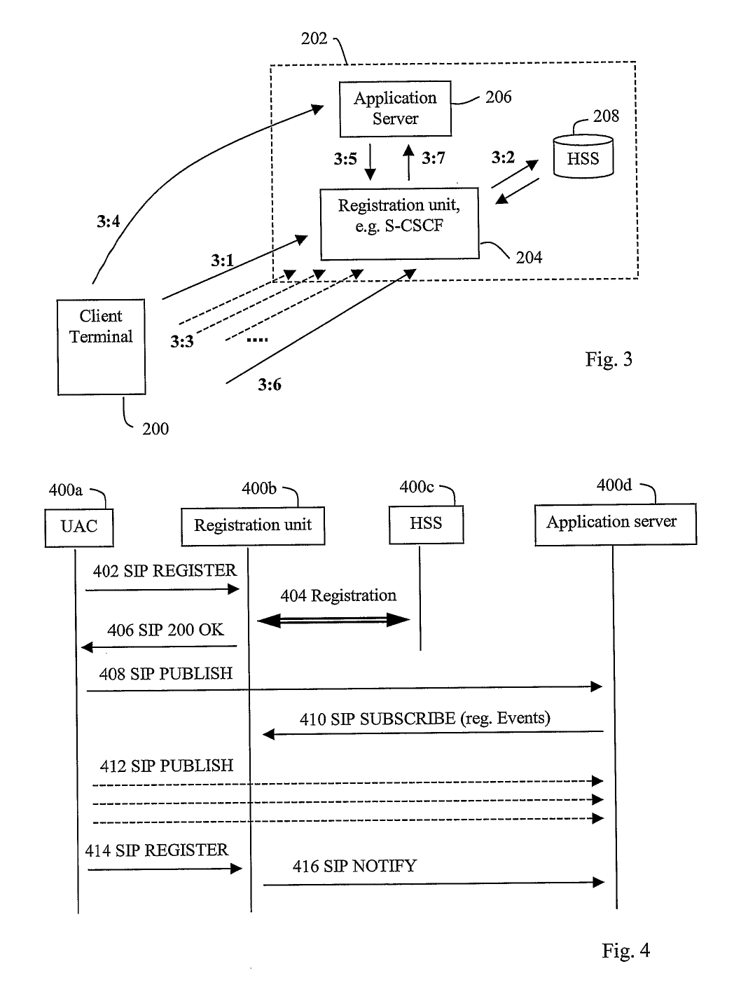

An embodiment of the present solution will now be described with reference to a block diagram shown in FIG. 3, using the same reference numerals as in FIG. 2 for corresponding elements. Also, the first part of the procedure is basically the same as described in connection with FIG. 2. Thus, terminal 200 sends a registration request message in a first step 3:1, and the terminal is registered in the HSS 208 in a next step 3:2. Further, it is still required that the terminal frequently sends re-registration messages to the registration unit 204, indicated by a step 3:3, in order to keep the registration “alive” and valid.

At some point during this ongoing procedure, terminal 200 sends a message to application server 206, in a step 3:4, that generally results in the activation of a client state in the application server. As explained above, this message is typically a client data publication message or a data subscription request message, but may also be a session initiation message, e.g. SIP INVITE, if the session remains active for a long time. Application server 206 will then maintain a client state involving some client-related information, typically relating to published data or a subscription for data.

However, in order to avoid the sending of frequent refresh messages for maintaining this client state in the application server 206, the application server 206 starts to monitor registration events related to the client's registration. In this example, the application server 206 sends a subscription request for registration events to the registration unit 204, in a step 3:5. Alternatively, registration events of a third party may be monitored.

In this description, the term “registration events” refers to any events when the client registration is changed, as handled by the registration unit 204 in this example. One important registration event is when the client has sent a de-register message, as in step 2:6 of FIG. 2 above, and the client's registration is consequently inactivated in the service network 202. The client's registration may also be inactivated if no refreshing re-registration messages has been received during the latest time-out period, e.g. due to lost radio contact or empty battery.

Thus, if the registration unit 204 receives a de-register message from the client 200, in a step 3:6, it will send a registration event notification concerning the client to the application server 206, in a next step 3:7, informing the application server that the client is no longer registered as active in the service network 202. The same registration event notification may be sent if the registration has timed-out without being refreshed. As a result, the application server 206 will finally update the client state in response to the received registration event notification. Typically, it will inactivate the client state in response to inactivation of the client's registration with the service network.

In this solution, the terminal is not required to refresh the published data by frequently sending a “re-publish” message, although it may of course send further publish messages, as in step 3:4, whenever the published data has changed. Since the application server can now rely on registration event notifications from the registration unit 204 for controlling the client state, the expiry time for the client state can be set very long to ensure that practically no refreshing re-publish or re-subscribe messages are sent from the client 200. Preferably, the expiry time for the client state is set significantly longer than the expiry time for the client registration, e.g. 10 times or more. This will significantly decrease the amount of signalling from the client, and the client-related information stored in the application server will still be kept up-to-date.

Of course, the client may still send a specific de-publish or de-subscribe message, not shown, to the application server 206 to inactivate the client state, which however does not affect the present inventive solution.

An exemplary signalling procedure according to a preferred embodiment will now be described for a client publishing data, with reference to FIG. 4. The figure shows a User Agent Client UAC 400a operating in a client terminal, a registration unit 400b, an HSS 400c and an application server 400d, which may all be equal to the corresponding elements in FIG. 3. In the present example, SIP signalling is used in an IMS network. It should be noted that in an IMS network, basically all the signalling with the client is actually handled by a P-CSCF node, as described in the background section, although omitted in this figure for the sake of simplicity.

When the client starts his/her terminal 400a, a User Agent Client UAC therein will send a SIP REGISTER message to the registration unit 400b, in a first step 402, to register a “Public User Identity, PUI” and tie it to the IP-address assigned to the terminal. In response thereto, the UAC 400a is registered in the network by means of a signalling dialog between the registration unit 400b and the HSS 400c, as schematically illustrated in a step 404. After establishing the client's registration, registration unit 400b sends a SIP 200 OK message to UAC 400a, in a step 406.

The UAC 400a will also frequently send refresh REGISTER messages, not shown, to the registration unit 400b to maintain the registration. The registration unit 400b will keep the registration active and use a timer function determining when the registered PUI shall be de-registered if the timer has expired. When the registration has expired, that PUI is unavailable for communication on that device. Further, when a UAC wants to initiate, modify or remove data on application server 400d, generally referred to as the publishing of data, it will send a new PUBLISH message to the application server 400d. It should be noted that several different UAC's may use the same terminal, and any of those can send PUBLISH messages to initiate or modify its particular service data.

In a further step 408, an initial SIP PUBLISH message is sent from UAC 400a for a certain PUI to the application server 400d. In response thereto, application server 400d initiates a subscription for registration events, by sending a subscription request, SIP SUBSCRIBE (reg. Events), in a step 410 to the registration unit 400b, in order to be informed on any changes in the registration state of the PUI. Alternatively, the registration unit 400b may use third party registrations to always send registration events to the application server 400d.

The application server 400d will now know when a PUI has been de-registered since the registration unit 400b has a time-out function related to the registration TTL, without requiring the UAC to send re-PUBLISH messages. To minimize the traffic between the registration unit 400b and the application server 400d, application server 400d may only subscribe for de-registering events, since there is, no point for the application server 400d to be informed about registration refreshing messages. In fact, the application server 400d needs no active timer for the published data at all, since it can safely trust that it will be informed by the registration unit 400b if a de-registration occurs. The UAC 400a may still send PUBLISH messages to the application server 400d as usual whenever the state of the published data needs to be changed, as indicated by optional steps 412.

Eventually, when the client's terminal is powered off, a SIP REGISTER (off) message is sent from UAC 400a to the registration unit 400b in a step 414. The published data is then invalidated as registration unit 400b sends a SIP NOTIFY (reg. Event(off)) message to application server 400d, in a final step 416.

While the invention has been described with reference to specific exemplary embodiments, the description is generally only intended to illustrate the inventive concept and should not be taken as limiting the scope of the invention, which is defined by the appended claims.

1. A method of handling client-related information in an application server connected to a telecommunication network, for a client who has registered with a registration unit in said telecommunication network, the client being required to send one or more re-registration messages to the registration unit in order to maintain the client registration, said method comprising the following steps as executed by said application server:
receiving a message from the client;
activating a client state in the application server in response to receiving the message, wherein the client state is maintained by means of said re-registration messages;
monitoring registration events when the client's registration is changed, as handled by the registration unit;
receiving a registration event notification concerning the client from the registration unit, said event notification indicating that the client registration has changed; and
updating the client state in response to the received registration event notification.

2. The method according to claim 1, wherein said message received from the client includes a publication of client data.

3. The method according to claim 1, wherein said message received from the client includes a subscription request for client data.

4. The method according to claim 1, wherein said message received from the client is a session initiation message.

5. The method according to claim 1, wherein said step of monitoring registration events includes creating a subscription for registration events.

6. The method according to claim 1, wherein said step of monitoring registration events includes monitoring registration events of a third party.

7. The method according to claim 1, further comprising inactivating the client state in the application server when the received registration event notification indicates that the client's registration with said telecommunication network has been inactivated.

8. (canceled)

9. The method according to claim 7, wherein the client's registration with said service network has a limited time of validity, and the method further comprises inactivating the client state in the application server when the client's registration with said telecommunication network has been inactivated when the time of registration validity has expired.

10. (canceled)

11. The method according to claim 9, wherein the client state in the application server also has a limited time of validity, and the expiry time of client state validity is greater than the expiry time of registration validity.

12. The method according to claim 11, wherein the expiry time of client state validity is at least 10 times the expiry time of registration validity.

13. The method according to claim 1, wherein the telecommunication network is an IMS network, and said registration event notification is received from an S-CSCF that handles the client's registration with said IMS network.

14. The method according to claim 13, wherein SIP is used for communicating messages with the client.

15. An arrangement in an application server connected to a telecommunication network, for handling client-related information for a client who has registered with a registration unit in said telecommunication network, the client being required to send one or more re-registration messages to the registration unit in order to maintain the client registration, said arrangement comprising:
means for receiving a message from the client;
means for activating a client state in the application server in response to receiving the message, wherein the client state is maintained by means of said re-registration messages;
means for monitoring registration events when said client registration is changed, as handled by the registration unit;
means for receiving a registration event notification concerning the client from the registration unit, said event notification indicating that the client registration has changed; and
means for updating the client state in response to the received registration event notification.

16. The arrangement according to claim 15, further comprising means for receiving said message from the client including a publication of client data.

17. The arrangement according to claim 15, wherein the means for receiving the message from the client includes means for receiving a subscription request for client data.

18. The arrangement according to claim 15, wherein the means for receiving the message from the client includes means for receiving a session initiation message.

19. The arrangement according to claim 15, wherein said means for monitoring registration events includes means for creating a subscription for registration events.

20. The arrangement according to claim 15, wherein said means for monitoring registration events includes means for monitoring registration events of a third party.

21. The arrangement according to claim 15, further comprising means for inactivating the client state in the application server when the received registration event notification indicates that the client's registration with said telecommunication network has been inactivated.

22. (canceled)

23. The arrangement according to claim 21, wherein the client's registration with said telecommunication network has a limited time of validity, and the arrangement further comprises means for inactivating the client state in the application server when the client's registration with said telecommunication network has been inactivated when the time of registration validity has expired.

24. (canceled)

25. The arrangement according to claim 23, wherein the client state in the application server also has a limited time of validity, and the arrangement further comprises means for setting the expiry time of client state validity to a value greater than the expiry time of registration validity.

26. The arrangement according to claim 25, wherein the means for setting the expiry time of client state validity includes means for setting the expiry time of client state validity to a value at least 10 times the expiry time of registration validity.

27. The arrangement according to claim 15, wherein the telecommunication network is an IMS network, and said registration event notification is received from an S-CSCF that handles the client's registration with said IMS network.

28. The arrangement according to claim 27, wherein SIP is used for communicating messages with the client.
